(19) United States
(12) Patent Application Publication
(10) Pub. No.: US 2013/0150157 A1
(43) Pub. Date: Jun. 13, 2013

(54) SLOT MACHINE CELEBRATION TOPPER

(71) Applicant: HAPP CONTROLS, INC., Mount Prospect, IL (US)

(72) Inventor: James LOSSER, Streamwood, IL (US)

(73) Assignee: HAPP CONTROLS, INC., Mount Prospect, IL (US)

(21) Appl. No.: 13/632,696

(22) Filed: Oct. 1, 2012

Related U.S. Application Data
(60) Provisional application No. 61/541,299, filed on Sep. 30, 2011.

(51) Int. Cl. G07F 17/32

(52) U.S. Cl. CPC G07F 17/3211
USPC 463/31

(57) ABSTRACT

A celebration topper for a gaming device has a main control communicating with an SAS interface and media, event modules and display units, an interface interpreting SAS communication and providing a signal output a jackpot “event” is detected so that a fiber optic fireworks plume and a streamer tube can be activated as a reaction to an event signal.

### BACKGROUND

### Field of Invention

The present technology relates generally to slot machine celebration toppers, and more particularly to universal displays activated based on customizable setting from a user.

### SUMMARY

A celebration topper is provided with a marquee display device intended for use on slot machines. The device implements various technologies for the purpose of attracting players to the host machines, and to react to game events, primarily an attendant paid jackpot. When a jackpot is won on a host machine, the topper will react with various attention grabbing events (for example, fireworks light show, confetti launch, display video, etc.). Each event device is modularly attachable to the topper, and can be added or removed depending on a user's configuration requirements. Additionally, the marquee is a modular design that allows for customized graphics to be added depending on the user's requirements.

Slot machines are typically electronically operated and controlled and interconnected to casino management networks and systems. U.S. Pat. No. 7,841,938 describes different types of games, but also describes the set-up of regulatory meters and a casino management system. The disclosure of this patent is incorporated by reference as if fully set forth herein. Similarly as part of the operation of slot machines, electronic signals are generated while the machine is in operation. Published US Patent Application Pub. No. US 2002/0160826 describes a different type of “topper” interconnected across different slog machines, but also describes the mode and manner of signal generation when one of the slot machines reaches a particular state and signals the system. The disclosure of this publication is incorporated by reference as if fully set forth herein.

### BRIEF DESCRIPTION OF DRAWINGS

FIG. 1 is an isometric view of a preferred embodiment of a celebration topper for a slot machine.

FIG. 2 is an exploded view of a preferred embodiment of a celebration topper for a slot machine.

FIG. 3 is an exemplary display of a fiber optic assembly embodied in a celebration topper.

FIG. 4 is an exemplary display of a confetti launch module embodied in a celebration topper.

FIG. 5 is a block diagram of the system electronics for a preferred embodiment of a celebration topper for a slot machine.

FIG. 6 is a block diagram of an SAS device for detecting a jackpot event.

### DETAILED DESCRIPTION

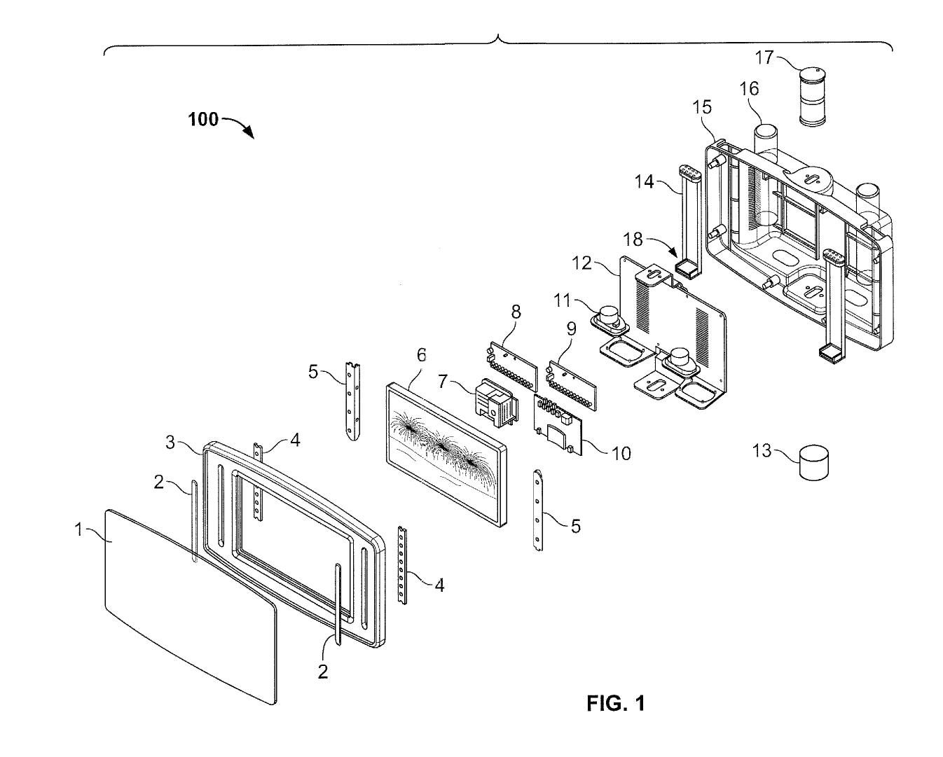

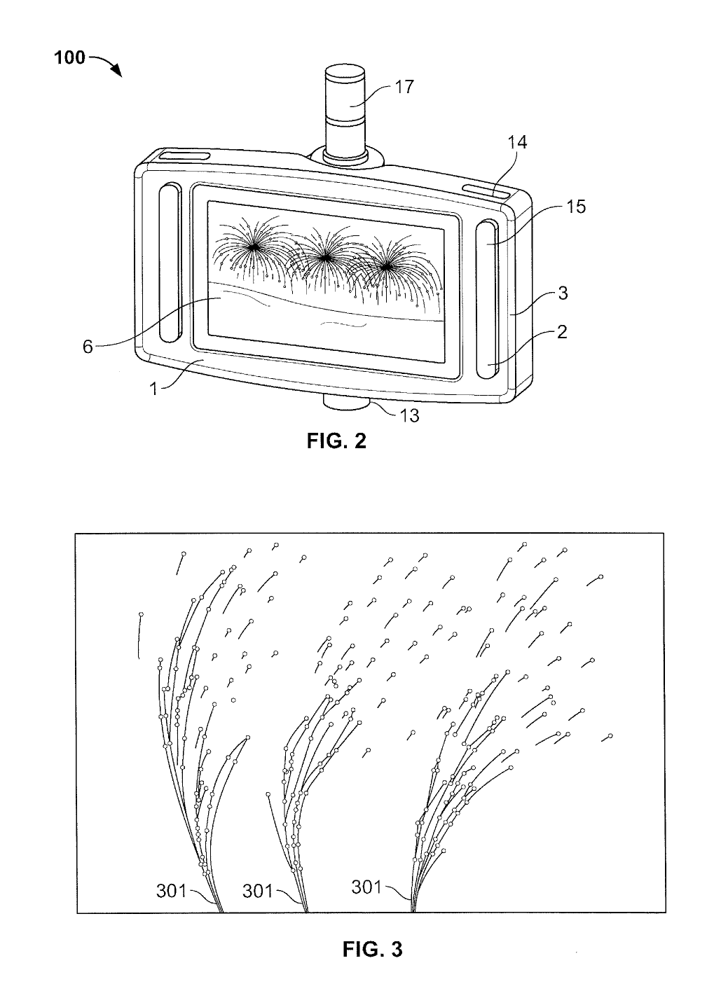

Referring now to FIG. 1 and FIG. 2, a celebration topper 100 is provided. Specifically referring to FIG. 1, a front bezel cover 1, such as an acrylic or polycarbonate sheet, is added to a front surface of the celebration topper 100 to provide a clear, shiny surface. Red-Green-Blue (RGB) Light Emitting Diode (LED) diffusers 2 fit within a front bezel 3. The RGB LED diffusers 2 are preferably flat rather than curved so as to keep the front surface of the topper 100 consistently flat, connect to RGB LED printed circuit board assemblies (PCBA) 4, and are mounted to mounting brackets 5. The front bezel 3 is preferably configured to receive any type of display unit 6, such as LCD or an optional edge lit plexi (plexiglass or acrylic) blacklight.

An amplifier assembly 7, a main control PCBA 8, a Slot Accounting System (SAS) PCBA 9, and a media PCBA 10 are mounted behind the display unit 6 within the celebration topper 100. As one of ordinary skill will be aware SAS is a protocol approved by the Gaming Standards Association (GSA) for operating, interfacing and accounting for slot machine activity. Indeed, many, if not all, states that set legal standards for gaming adopt or reference the GSA SAS. Accordingly, one of ordinary skill will be aware of the standards used by the protocol and the technical requirements for signal interfacing with SAS.

The main control PCBA 8 may include serial peripheral interface (SPI) and/or RS232 communication for peripherals or any other communication signals that are well known in the art to allow for wireless radio control and/or wired communication with SAS interface PCBA 9, media PCBA 10 and/or event modules (eg. fiber optic assembly 14, streamer tube 16, or tower light 17). The amplifier assembly 7 provides stereo audio amplification to speakers 11 or any optional external speakers (not shown), creating a sound module which is controlled by the main control 8. Support frame 12 and base collar 13 provides support for the celebration topper 100, radio frequency (RF) shielding for electronics, and an electrostatic discharge (ESD) path.

Fiber optic assembly 14 is a retractable assembly that provides an illuminated “fireworks” display. The fiber optic assembly 14 can be retracted within or raised above the celebration topper 100 by any mechanical means such as a fiber optic lifting mechanism 18 well known in the art. Rear housing 15 attaches to front bezel 3 to enclose the majority of the above mentioned components. Rear housing 15 holds streamer tube inserts 16, which hold streamer (or confetti) launch tubes in place. Activating or detonating components within tube launch mounting housings 400 are well known in the art. Rear housing 15 also holds tower light 17.

Display unit 6 will provide a marquee area, customizable to allow for different graphics to be attached to the celebration topper 100. Although the display unit 6 is shown with a standard shape, the unit 6 may be customized to any shape. An alternate embodiment of display unit 6 may include a backlight powered by a pulse width modulation (PWM) signal from the main control 8 to allow for dimming and event reaction.

Event modules (for example the fiber optic assembly 14, streamer tube inserts 16, and tower light 17) can be controlled by the main control 8. The celebration topper 100 is customizable to include other modular units that are well known in the art.

The celebration topper 100 includes power supplies (not shown) in order to power all components of the celebration topper.

Referring now to FIGS. 1 and 3, the fiber optic assembly 14 would act as a “fireworks plume” module consisting of a series of lighted fiber optic bundles 301 that attach to the top of the display unit 6 or celebration topper 100, giving the appearance of a fireworks plume. The number of fiber optic strands per module and number of modules to be used per celebration topper 100 is customizable. Lighting of the fiber optic assembly 14 may be provided by an array of RGB LEDs, or other lighting system well known in the art, controlled by the main controller 8. A “fireworks plume” is only visible when a celebration “event” (for example jackpot or attendant payout) has been triggered. The fiber optic assembly 14 is normally hidden within the celebration topper 100 housing (consisting of front bezel 3 and rear housing 15) and emerges when an “event” is triggered from the main controller 8.

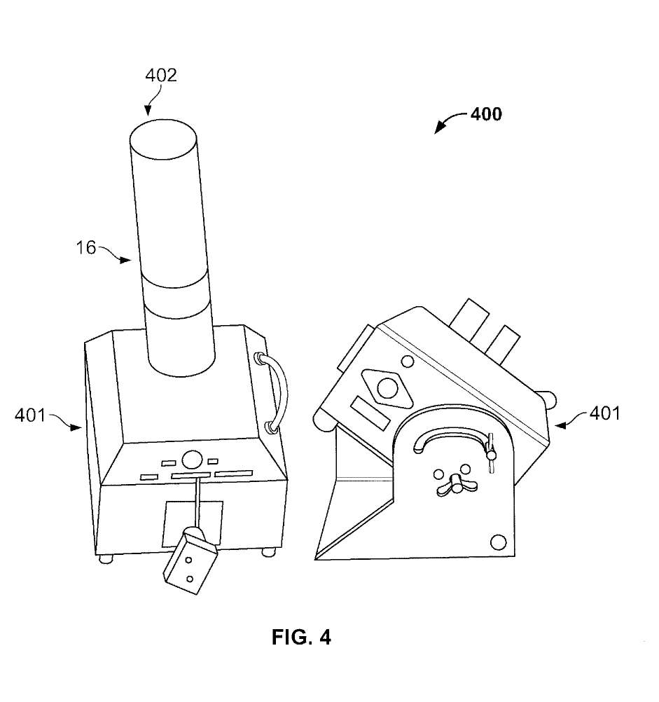

Referring now to FIGS. 1 and 4, the streamer tube 16 will hold a streamer or confetti launch device 401 consisting of a disposable and/or refillable module that will launch confetti (not shown) or similar material (streamers, “flutter fetti,” etc). The confetti launch device launches the confetti into the air as a reaction to an “event” signal from the main controller 8. The launching of the confetti payload may be supplied by compressed air or similar method located within celebration topper 100.

A media module consisting of display unit 6 and media PCBA 10 allow for playback and display of stored media content, such as pre-recordings, looping video, event videos, or other display media known in the art. The media PCBA 10 may also communicate with and play media through the above mentioned sound module consisting of the amplifier 7 and speakers 11.

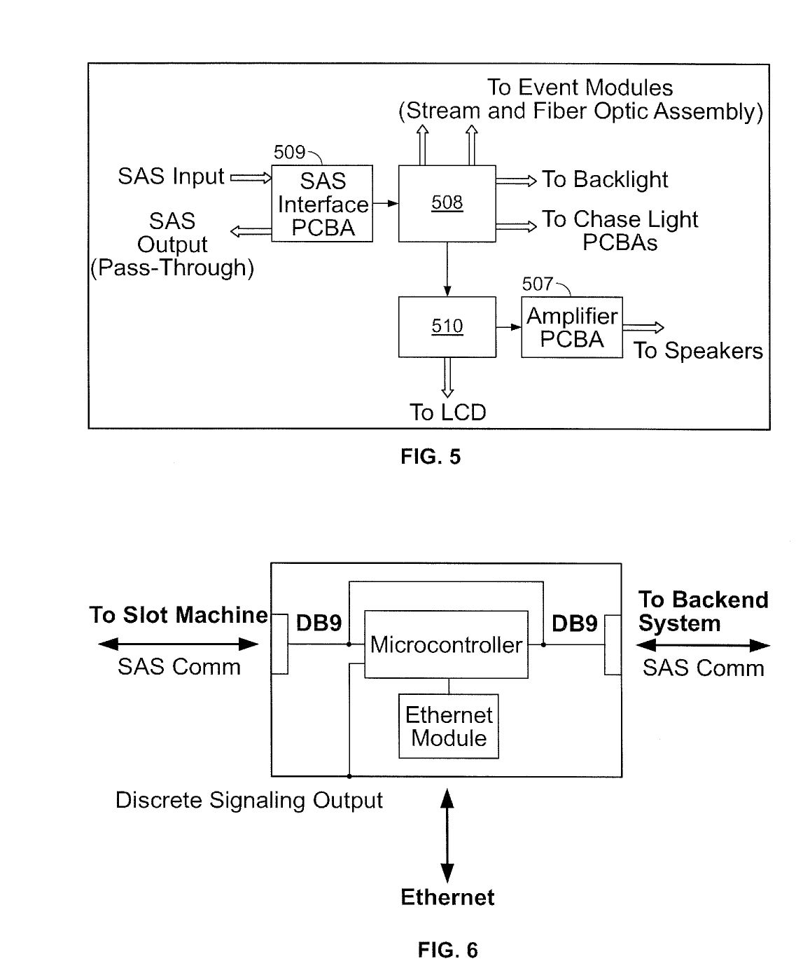

Referring now to FIG. 5, the main control 508 communicates with an SAS interface 509 and media PCBA 510, as well as any event modules and display units. The main control 508 provides control of the overall system via an embedded microcontroller or microprocessor which is well known in the art. The SAS interface 509 interprets SAS communication and provides a signal output to the main control 508 when a jackpot “event” is detected.

Regarding detection of a jackpot “event,” the SAS interface 509, which may be an external device or a device within the celebration topper 100 may directly connect or “sniff” communication from a host slot machine (not shown) to detect a jackpot “event,” also known as an attendant paid jackpot. FIG. 6 shows a block diagram of the SAS interface 509. The device 509 will intersect an SAS communication, and is configured to detect when a hand payout occurs based on an analysis of polls/responses. The device may comprise a PCBA powered by a microcontroller that connects to an optocoupler (or raise a pin to TTL level) when there is an attendant paid jackpot. The device can be configured by a user (for example, by setting a bank of dip switches) to set a predetermined jackpot threshold. Additionally, the device can be configured to determine the jackpot event that has occurred via the SAS communication, and relay this jackpot information to the main control 508. Once the device determines through the SAS communication that a jackpot event that exceeds the threshold has occurred, the device will send a signal to the main control 508. The main control 508 then communicates with any event modules and display units that are controlled by the main control 508. The main control 508 instructs the event modules to react or activate according to the jackpot event that has occurred. For example, a “chase” lighting may be displayed, wherein the main control 508 could transmit serial data to various LEDs in a “chase” pattern. Alternative embodiments allow for the shifting of the data to a parallel output via shift registers and/or a driver circuit, or an integrated LED driver.

Specifically, an embodiment of the SAS interface 509 will include 2 IDC connectors to connect to the SAS communication line as an input and an output to the device (see FIGS. 5 and 6). Once a jackpot is detected an optocoupler is used to connect the SAS interface 509 to the main controller 508 allowing for effective communication. As previously stated, communication between the SAS interface 509 and the main controller 508 may be by serial communication (eg. SPI or RS232), or may also be a simple trigger (such as open collector output). The SAS interface 509 may include 3 LEDs to display the power, board activity, and when an attendant signal is occurring.

A method of detecting a jackpot “event” uses a SAS communication common to many gaming machines. As described above SAS is a protocol that is well known in the art as a standard for communication between gaming machines and slot accounting systems. A jackpot “event” is communicated through SAS communication and extracted from the communication stream. The above-mentioned device will parse an SAS exception or the answer of a long poll, as an indication to output a signal.

Numerous modifications to the features described and shown are possible. Accordingly the described and illustrated embodiments are to be construed as merely exemplary of the inventive concepts expressed herein.

1. A celebration topper 100 for a gaming device incorporates a front bezel cover 1, with a display unit 6 mounted therein;
an amplifier assembly 7, a main control printed circuit board (PCBA) 8, a Slot Accounting System (SAS) PCBA 9, and a media PCBA 10 mounted behind said display unit 6;
said main control PCBA 8 includes a communication interface selected from the group consisting of a serial peripheral interface (SPI), a RS232 communication for peripherals and wireless radio control;
an event modules operatively connected to said slot machine, said event module comprising one or more of a fiber optic assembly 14, streamer tube assembly 400, and tower light 17;
a sound module comprising said amplifier assembly 7 which provides stereo audio amplification to speakers 11;
a support frame 12 and base collar 13 which provide mechanical support for the celebration topper 100, radio frequency (RF) shielding for electronics, and an electrostatic discharge (ESD) path;
said fiber optic assembly 14 is retractable within or raised above the celebration topper 100 by fiber optic lifting mechanism 18;
a rear housing 15 attaches to front bezel 3 to enclose fiber optic assembly 14; streamer tubes 16 operatively connected to launch tube assemblies 400 and tower light 17;
said display unit 6 further comprises
Light Emitting Diode (LED) diffusers 2 fit therein,
a marquee area adapted to display different graphics.
a backlight powered by a pulse width modulation (PWM) signal from the main control 8 to allow for dimming and event reaction;
said fiber optic assembly 14 acts as a “fireworks plume” module consisting of a series of lighted fiber optic bundles 301 that attach to the top of the display unit 6 or celebration topper 100, giving the appearance of a fireworks plume, said “fireworks plume” is only visible when a celebration “event” (for example jackpot or attendant payout) has been triggered and is normally hidden within the celebration topper 100 housing consisting of front bezel 3 and rear housing 15;
streamer tube 16 is operatively connected to a streamer or confetti launch device 401 consisting of a disposable and/or refillable module that will launch confetti 402 as a reaction to an “event” signal.

2. A celebration topper 100 for a gaming device incorporates a front bezel cover 1, with a display unit 6 mounted therein;
an amplifier assembly 7, a main control printed circuit board (PCBA) 8, a Slot Accounting System (SAS) PCBA 9, and a media PCBA 10 mounted behind said display unit 6;
said main control PCBA 8 includes a communication interface selected from the group consisting of a serial peripheral interface (SPI), a RS232 communication for peripherals and wireless radio control;
an event modules operatively connected to said slot machine, said event module comprising one or more of a fiber optic assembly 14, streamer tube assembly 400, and tower light 17;
a sound module comprising said amplifier assembly 7 which provides stereo audio amplification to speakers 11;
a support frame 12 and base collar 13 which provide mechanical support for the celebration topper 100, radio frequency (RF) shielding for electronics, and an electrostatic discharge (ESD) path;
said fiber optic assembly 14 is retractable within or raised above the celebration topper 100 by fiber optic lifting mechanism 18;
a rear housing 15 attaches to front bezel 3 to enclose fiber optic assembly 14; streamer tube launch tubes 16 operatively connected to launch tube assemblies 400 and tower light 17.

3. The invention of claim 2 further comprising the display unit comprises Light Emitting Diode (LED) diffusers 2 fit therein;

4. The invention of claim 2 further comprising display unit 6 provides a marquee area adapted to display different graphics.

5. The invention of claim 2 further comprising display unit 6 includes a backlight powered by a pulse width modulation (PWM) signal from the main control 8 to allow for dimming and event reaction.

6. The invention of claim 2 further comprising said fiber optic assembly 14 acts as a fireworks plume module consisting of a series of lighted fiber optic bundles 301 that attach to the top of the display unit 6 or celebration topper 100, giving the appearance of a fireworks plume.

7. The invention of claim 6 further comprising said fireworks plume is only visible when a celebration event has been triggered.

8. The invention of claim 2 further comprising said fiber optic assembly 14 is normally hidden within the celebration topper 100 housing consisting of front bezel 3 and rear housing 15 and emerges when an event is triggered from the main controller 8.

9. The invention of claim 2 further comprising streamer tube 16 is operatively connected to a streamer or confetti launch device 401 consisting of a disposable and/or refillable module that will launch confetti 402 or similar material (streamers, “flutter fetti,” etc) as a reaction to an “event” signal from the main controller 8.

10. The invention of claim 9 further comprising the launching of the confetti payload may be supplied by compressed air.

11. The invention of claim 2 further comprising a media module consisting of display unit 6 for playback and display of stored media content, comprising one of pre-recordings, looping video, event videos, or other display media known in the art.

12. A celebration topper for a gaming device comprising:
A main control 508 communicating with an SAS interface 509 and media PCBA 510, event modules and display units;
said main control 508 providing control of the overall system via an embedded microcontroller or microprocessor;
an interface 509 interprets SAS communication and provides a signal output to the main control 508 when a jackpot “event” is detected.

13. The invention of claim 12 further comprising:
interface 509 intersect an SAS communication and detects when a hand payout occurs based on an analysis of polls/responses;
said interface 509 comprises a PCBA powered by a microcontroller that connects to one of an optocoupler or pin reflecting a TTL logic level when there is an attendant paid jackpot.

14. The invention of claim 12 further comprising:
device 509 is user configurable to set a predetermined jackpot threshold.

15. The invention of claim 12 further comprising:
device 509 is configured to determine the jackpot event that has occurred via the SAS communication, and relay this jackpot information to the main control 508.

16. The invention of claim 12 further comprising:
interface 509 includes 2 IDC connectors to connect to the SAS communication line as an input and an output to the device.

17. The invention of claim 12 further comprising a fiber optic assembly 14 forms a fireworks plume module consisting of a series of lighted fiber optic bundles 301 that attach to the top of display unit 6 of celebration topper 100, said fireworks plume is only visible when a celebration event has been triggered but is normally hidden within the celebration topper 100 housing consisting of front bezel 3 and rear housing 15.

18. The invention of claim 12 further comprising a streamer tube 16 operatively connected to a streamer or confetti launch device 401 consisting of a disposable and/or refillable module that will launch confetti 402 as a reaction to an event signal.
